(19) United States
(12) Patent Application Publication
(10) Pub. No.: US 2008/0000883 A1
(43) Pub. Date: Jan. 3, 2008

(54) Method for the end-side welding of metal sheets

(75) Inventors: Heiko Rudolf, Bokensdorf (DE); Volker Tessmar, Sassenburg (DE); Sven Juttner, Wolfsburg (DE); Bernd Grosser, Braunschweig (DE)

Correspondence Address: LERNER GREENBERG STEMER LLP, P O BOX 2480, HOLLYWOOD, FL, 33022-2480, US

(73) Assignee: Volkswagen Aktiengesellschaft

(21) Appl. No.: 11/824,196

(22) Filed: Jun. 29, 2007

(30) Foreign Application Priority Data
Jun. 29, 2006 (DE) 10 2006 030 060.2

(51) Int. Cl. B23K 26/24; B23K 26/20; B23K 15/00; B23K 9/00

(52) U.S. Cl. 219/121.64; 219/121.14; 219/137 R

(57) ABSTRACT

A method for the end-side welding of at least two metal sheets disposed on one another in sections, includes selecting welding parameters such that, in the metal sheets to be connected, at least one of which is composed of a high-strength steel, a temperature with which the high-strength steel of the at least one metal sheet is tempered is generated at least in direct vicinity of an end-side weld seam. In addition, through a suitable selection of the welding parameters, a weld pool volume forming the weld seam is generated at an end side of the metal sheets. The weld pool volume has a width greater than the width of the end side of the metal sheets. Therefore, an undercut can be generated between the outer sides of the metal sheets and the weld seam. A form-locking connection can thereby be generated between the metal sheets and the weld seam.

### CROSS-REFERENCE TO RELATED APPLICATION

This application claims the priority, under 35 U.S.C. §119, of German Patent Application DE 10 2006 030 060.2, filed June 29, 2006; the prior application is herewith incorporated by reference in its entirety.

### BACKGROUND OF THE INVENTION

### Field of the Invention

The invention relates to a method for the end-side welding of at least two metal sheets which are disposed on one another in sections.

A method of the type specified in the introduction is, for example, already described in German Published, Non-Prosecuted Patent Application DE 101 27 714 A1. In order to produce motor vehicle doors and flaps, in that document two metal sheets which are disposed on one another in sections are connected to one another through the use of plasma welding at the end side. The weld seam is matched in terms of its width to the corresponding width of the end side, and completely covers the latter. The document does not give any indication of the materials which are to be welded by using that method.

German Published, Non-Prosecuted Patent Application DE 100 48 233 A1 likewise describes a method for the plasma welding of body flanges through the use of a weld seam disposed at the end side. The weld seam, which is embodied as a flanged seam, connects only those edges of the body flanges, which are to be connected and are disposed on one another, that face toward one another. The document also does not give any indication of the materials to be welded by using that method.

German Published, Non-Prosecuted Patent Application DE 36 00 532 A1, corresponding to U.S. Pat. No. 4,758,704, German Utility Model DE 84 28 701 U1 and German Published, Non-Prosecuted Patent Application DE 42 07 046 A1 also describe similar methods for the end-side welding of metal sheets which are disposed on one another.

In body construction, various methods are presently used for joining body components or when joining metal body sheets to body components. In recent years, it has been possible to considerably improve static and dynamic strength, and thereby crash behavior, by using laser beam welding, for example in the region of a door opening. In laser beam welding, a linear connection is generated in the region of a flange in which the metal sheets that are to be connected are disposed on one another or so as to overlap. In that case, a laser beam is directed perpendicularly at a surface of a first metal sheet in the center of the flange, and both the material of that metal sheet as well as the material of the metal sheet disposed below it are melted and connected to one another through the use of a weld seam. Due to the configuration of the weld seam in the region of the flange, the flange must have a corresponding minimum width. Furthermore, laser beam welding requires a high expenditure for joining point preparation, for example with regard to spacing, evenness and offset of the metal sheets. Due to the high investment costs, in particular for the laser system and the required peripheral units, the method is particularly expensive to carry out in particular in the case of small batch sizes.

Another method used for joining body components is spot welding. In spot welding, the metal sheet components which are situated on one another are welded to one another in a flange region through the use of a plurality of punctiform connections which are disposed at a defined spacing from one another. The spot welding process is used, for example, to connect components in the region of body door openings, at openings for the front and rear windshields and for the sealing flange of the tailgate, etc. Due to the construction of the required spot welding tongs, the flanges must have a minimum width, which opposes in particular the promotion of weight reduction. In the case of spot welding, creaking noises or else so-called flange pumping can occur depending on the spacing of the individual weld spots and of the respective loading of the body components. When using spot-welding for high-strength or super-high-strength steels, such as for example boron-alloyed heat-treated steel 22MnB5, which are increasingly used as reinforcements in the region of body pillars, each spot weld entails a predetermined breaking point.

### SUMMARY OF THE INVENTION

Against this background, it is accordingly an object of the invention to provide a method for the end-side welding of metal sheets, which overcomes the hereinafore-mentioned disadvantages of the heretofore-known methods of this general type and through the use of which required flange widths for welding can be reduced. At the same time, a connection which can be produced reliably should be ensured even when using a component made from a high-strength or super-high-strength steel.

With the foregoing and other objects in view there is provided, in accordance with the invention, a method for the end-side welding of at least two metal sheets disposed on one another in sections. The method comprises providing at least one of the metal sheets as a high-strength steel sheet. Welding parameters for the metal sheets to be connected are selected to generate a temperature for tempering the high-strength steel of the at least one metal sheet, at least in a direct vicinity of an end-side weld seam. A weld pool volume is produced forming the weld seam at an end side of the metal sheets to be connected. The weld pool volume has a width greater than a width of an end side of the metal sheets to be connected. An undercut is produced between outer sides of the metal sheets and the weld seam.

As a result of the linear weld seam which is disposed at the end side and is embodied as a flanged seam or flat seam, the flange width can be considerably reduced without it thereby being necessary to accept losses with regard to the strength of the connection. The flange width can be reduced to the height of the weld seam and now serves merely to protect the weld pool. Furthermore, the reduction of the flange width results in design freedom in particular in terms of the body design, since for example the door opening, the luggage space opening and the window openings can be enlarged with otherwise unchanged outer dimensions of the body. In addition, the joining partners in the flange region need not be aligned entirely exactly relative to one another, since tolerances even in the metal sheet dimensions can be compensated for with the method according to the invention. In addition, form-locking engagement between the metal sheets and the weld seam can be generated through the use of the undercut, as a result of which the strength of the connection is improved overall. A form-locking connection is one which connects two elements together due to the shape of the elements themselves, as opposed to a force-locking connection, which locks the elements together by force external to the elements. The undercut can also be utilized for fastening seals, for example in the region of a body door opening. Furthermore, the method according to the invention generates a weld seam with geometrically favorable transitions to the metal sheets, that is to say with very smooth and round transitions, with the mechanical properties of the welded connection being positively influenced by the lack of notches and edges. In addition, it is also possible through the use of the method according to the invention to generate in particular multi-layer connections, with it also being possible for the joining partners to have different material thicknesses and different material characteristics. It is, for example, also possible for the high-strength and super-high-strength steels, for example boron-alloyed heat-treated steels (22MnB5), which are increasingly used in body construction, to be welded to a soft deep-drawn steel or a steel with a high yield strength. By tempering the high-strength and super-high-strength steel, the hardness in the region of the heat-affected zone is reduced, and at the same time, the toughness in that region is increased. In this way, the metal sheet made from the high-strength steel maintains its strength outside the heat-affected zone, and a reduced strength is generated only in the heat-affected zone, with the susceptibility to cracks under high loading of the sheet metal components, for example in the event of a crash, simultaneously being reduced.

In accordance with another mode of the invention, the welding can be carried out by using a very wide variety of welding processes, wherein it has been proven to be particularly advantageous if the end-side weld seam is generated through the use of a beam welding process, in particular laser beam welding or electron beam welding, with the temperature required for tempering, and the formation of a heat-affected zone in the metal sheets which are to be connected, and a sufficiently large weld pool volume at the end side of the metal sheets, being generated through the use of a variable adjustment of the welding speed and/or of the beam power. A determining factor for the temperature in the metal sheets and for the formation of the heat-affected zone is the energy introduced per unit length. By varying the energy introduced per unit length, it is possible to vary the size of the heat-affected zone. In general, the energy per unit length and therefore the heat introduced can be increased, for example, if the welding speed is reduced while maintaining the same beam power or if the jet power is increased while maintaining a constant welding speed. The energy per unit length can be correspondingly reduced through the use of a converse approach. In order to generate the undercut, the welding parameters are to be selected in such a way that such a quantity of material at the end side of the metal sheets is melted that the material is forced outward beyond the edges of the metal sheets. This is obtained through the use of such a high power or such a low welding speed that the weld pool assumes a volume which, due to its viscosity, has a greater width than the width of the end side of the metal sheets which are to be connected.

In accordance with a further mode of the invention, the end-side weld seam is generated by a gas-shielded welding process, in particular GMA welding or TIG welding, with the temperature required for tempering, and the formation of a heat-affected zone in the metal sheets which are to be connected, and a sufficiently large weld pool volume at the end side of the metal sheets, being generated through the use of a variable adjustment of the welding current and of the welding voltage and/or of the welding speed. The temperature and the formation of the heat-affected zone are likewise set through the use of the energy introduced per unit length. In gas-shielded welding, the energy per unit length and the heat introduced can be increased by increasing the welding current and welding voltage while maintaining the same weld speed or by reducing the welding speed while maintaining a constant welding current and welding voltage. A reduction of the energy per unit length can be obtained through the use of a converse approach. There, the undercut is generated by carrying out welding at such a high welding current or such a high welding voltage or else with such a low welding speed that the weld pool assumes a volume which, due to its viscosity, has a greater width than the width of the end side of the metal sheets which are to be connected.

It is fundamentally possible for the method according to the invention to be carried out without a filler material. In accordance with an added mode of the invention, one advantageous refinement of the method is also obtained in that, during the welding, a filler material is added, with a sufficiently large weld pool volume being generated by varying a filler material quantity, in particular a wire feed speed. The weld pool volume can hereby be adapted, without changing the other welding parameters, to the respective structural conditions, such as for example flange width, metal sheet thickness, material characteristics, etc.

In accordance with an additional mode of the invention, an advantageous refinement of the method according to the invention is also obtained in that, during the welding, the metal sheets are acted on in the region of a joining point through the use of a pressing force directed at the outer sides of the metal sheets in order to position the metal sheets in an assembly position. This ensures that the metal sheets, at least in the region of the joining location or point, are disposed on one another in such a way that an optimum weld seam with the desired or required undercut can be generated at the end side of the metal sheets.

In accordance with a concomitant mode of the invention, it has been proven to be particularly expedient if a pressing device, which generates the pressing force, and a welding device, are moved together in a feed direction. As a result of the common feed, the welding device and the pressing device are situated in a defined position relative to one another at all times.

Other features which are considered as characteristic for the invention are set forth in the appended claims.

Although the invention is illustrated and described herein as embodied in a method for the end-side welding of metal sheets, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a B pillar of a motor vehicle body;

FIG. 2 is an enlarged, fragmentary view of a flange illustrated in FIG. 1;

FIG. 3 is an elevational view of a welded connection produced through the use of the method according to the invention; and

FIG. 4 is a perspective view of the metal sheets during welding.

### DETAILED DESCRIPTION OF THE INVENTION

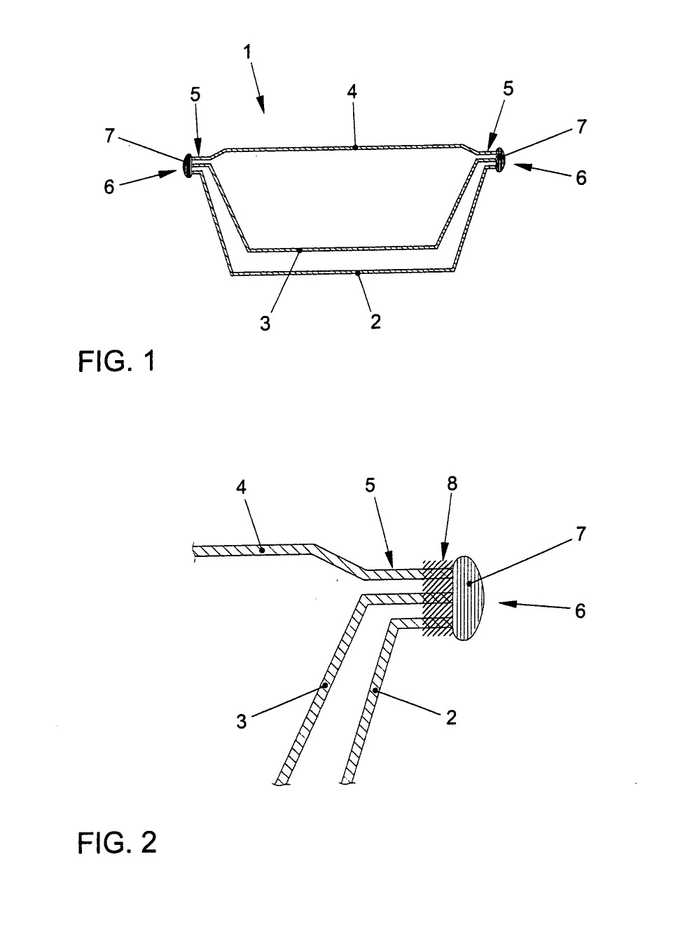

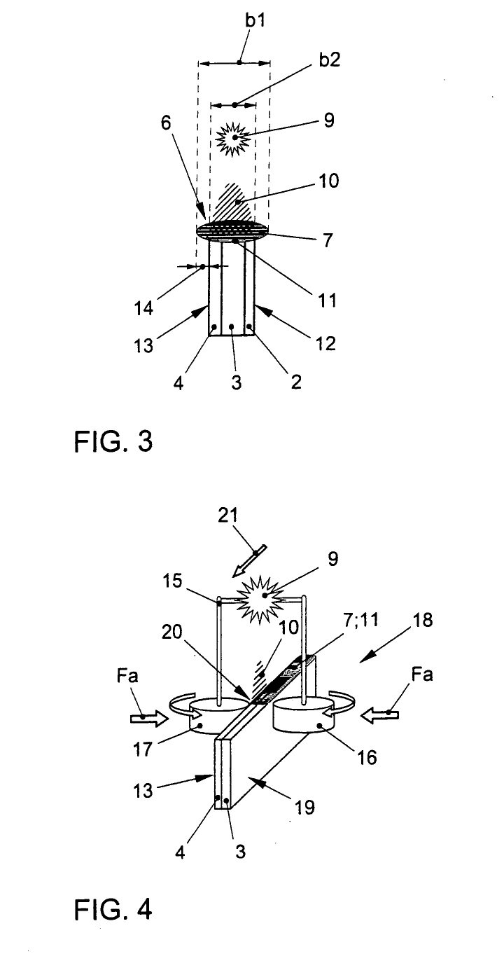

Referring now to the figures of the drawings in detail and first, particularly, to FIG. 1 thereof, there is seen a sectional illustration of a body pillar 1, which is embodied as a B pillar, of a motor vehicle. The body pillar 1 which is embodied as a B pillar has three metal sheets 2, 3, 4 that are each made from different materials and which, in a region of two flanges 5, are disposed on one another and are connected to one another through the use of a weld seam 7 disposed at an end side 6 of the metal sheets 2, 3, 4. The metal sheets 2, 3, 4 have different metal sheet thicknesses (see FIG. 3) and different steel characteristics. The metal sheet 2 is composed of a deep-drawn soft steel, in particular DC 05 ZE, while the metal sheet 3 is composed of a high-strength boron-alloyed heat-treated steel, in particular 22MnB5, and the metal sheet 4 is composed of a cold-formed steel with a high yield strength, in particular ZStE260 Z100.

FIG. 2 is an enlarged illustration of the flange 5 shown in FIG. 1. A heat-affected zone 8 which has a width of approximately 2 to 3 mm has been formed directly adjacent the weld seam 6 during the welding, and a temperature has at the same time been generated as a result of which the high-strength steel of the metal sheet 3 has been tempered. As a result of the tempering, the hardness of the metal sheet 3 made from the high-strength steel has been reduced in the region of the heat-affected zone 8, while at the same time the toughness has been increased. The structure of the metal sheet 3 made from the high-strength steel has been changed only in the region of the heat-affected zone 8. In this way, the strength or hardness of the metal sheet 3 is maintained in the regions outside the heat-affected zone 8.

FIG. 3 is a diagrammatic illustration of the welded connection 7 produced through the use of the method according to the invention during the welding of the end side 6 of the metal sheets 2, 3, 4 which are of different thicknesses. A weld pool volume 11 is generated at the end side 6 of the metal sheets 2, 3, 4 through the use of a heat beam 10 generated by a welding device 9. The weld pool volume 11 has a width b1 which is greater than a width b2 of the end side 6 of the metal sheets 2, 3, 4. Therefore, an undercut 14 is formed between the weld seam 7 or the weld pool volume 11 and outer sides 12, 13 of the outer metal sheets 2, 4. A form-locking connection is thereby formed between the metal sheets 2, 3, 4 and the weld seam 7 generated from the weld pool volume 11.

FIG. 4 shows a perspective view of the metal sheets 3, 4 during the welding. The welding device 9 is connected through the use of a coupling device 15 to a pressing device 18 which has two contact rollers 16, 17. The metal sheets 3, 4 which are to be welded are disposed between the two contact rollers 16, 17, with the outer sides 13, 19 of the metal sheets 3, 4 being acted on by the pressing device 18 with a pressing force Fa which positions the metal sheets 3, 4 in an assembly position in the region of a joining location 20. The welding device 9 and the pressing device 18, which are connected through the use of the coupling device 15, are moved together in a feed direction 21. The movement in the feed direction 21 is provided through the use of a drive device which is associated with the coupling device 15 or through the use of at least one driven contact roller 16, 17.

1. A method for the end-side welding of at least two metal sheets disposed on one another in sections, the method comprising the following steps:
providing at least one of the metal sheets as a high-strength steel sheet;
selecting welding parameters for the metal sheets to be connected, to generate a temperature for tempering the high-strength steel of the at least one metal sheet, at least in a direct vicinity of an end-side weld seam;
producing a weld pool volume forming the weld seam at an end side of the metal sheets to be connected, the weld pool volume having a width greater than a width of an end side of the metal sheets to be connected; and
producing an undercut between outer sides of the metal sheets and the weld seam.

2. The method according to claim 1, which further comprises producing the end-side weld seam by a beam welding process generating a temperature required for tempering, a formation of a heat-affected zone in the metal sheets to be connected and a sufficiently large weld pool volume at the end side of the metal sheets, by a variable adjustment of at least one of a welding speed or a beam power.

3. The method according to claim 2, wherein the beam welding process is a laser beam welding or electron beam welding process.

4. The method according to claim 1, which further comprises producing the end-side weld seam by a gas-shielded welding process generating a temperature required for tempering, formation of a heat-affected zone in the metal sheets to be connected and a sufficiently large weld pool volume at the end side of the metal sheets, by a variable adjustment of a welding current and at least one of a welding voltage or a welding speed.

5. The method according to claim 4, wherein the gas-shielded welding process is a GMA welding or TIG welding process.

6. The method according to claim 1, which further comprises adding a filler material and producing a sufficiently large weld pool volume by varying a quantity of the filler material during welding.

7. The method according to claim 6, which further comprises carrying out the step of varying the quantity of the filler material by varying a wire feed speed.

8. The method according to claim 1, which further comprises, during welding, acting on the metal sheets in a region of a joining location with a pressing force directed at outer sides of the metal sheets for positioning the metal sheets in an assembly position.

9. The method according to claim 8, which further comprises providing a pressing device generating the pressing force, and a welding device, and moving the pressing device and the welding device together in a feed direction.
